(19) United States
(12) Patent Application Publication
(10) Pub. No.: US 2025/0023095 A1
(43) Pub. Date: Jan. 16, 2025

(54) SOLID ELECTROLYTE MATERIAL AND BATTERY USING SAME

(71) Applicant: Panasonic Intellectual Property Management Co., Ltd., Osaka (JP)

(72) Inventors: TAKASHI KUBO, Hyogo (JP); KAZUFUMI MIYATAKE, Osaka (JP); YOSHIAKI TANAKA, Kyoto (JP); RYUHEI KATAYAMA, Osaka (JP); AKINOBU MIYAZAKI, Osaka (JP)

(21) Appl. No.: 18/900,635

(22) Filed: Sep. 28, 2024

Related U.S. Application Data
(63) Continuation of application No. PCT/JP2023/007417, filed on Feb. 28, 2023.

(30) Foreign Application Priority Data
Apr. 8, 2022 (JP) 2022-064603

(51) Int. Cl. H01M 10/0562; H01M 10/0525

(52) U.S. Cl. CPC H01M 10/0562; H01M 10/0525; H01M 2300/008

(57) ABSTRACT

The solid electrolyte material of the present disclosure is a solid electrolyte material including Li, M, O, and X. Here, M is at least one selected from the group consisting of Nb and Ta, X is at least one selected from the group consisting of F, Cl, Br, and I, and the solid electrolyte material has a specific surface area of greater than 7.5 m²/g. The battery of the present disclosure includes a positive electrode, a negative electrode, and an electrolyte layer arranged between the positive electrode and the negative electrode. At least one of the positive electrode, the negative electrode, and the electrolyte layer contains the solid electrolyte material of the present disclosure.

### BACKGROUND

### 1. Technical Field

The present disclosure relates to a solid electrolyte material and a battery using it.

### 2. Description of the Related Art

International Publication No. WO 2020/137153 discloses a solid electrolyte material including Li, M, O, and X. Here, M is at least one element selected from the group consisting of Nb and Ta, and X is at least one element selected from the group consisting of Cl, Br, and I.

### SUMMARY

One non-limiting and exemplary embodiment provides a solid electrolyte material having a practical ion conductivity and having improved accessibility to another material.

In one general aspect, the techniques disclosed here feature a solid electrolyte material comprising Li, M, O, and X, wherein M is at least one selected from the group consisting of Nb and Ta, X is at least one selected from the group consisting of F, Cl, Br, and I, and the solid electrolyte material has a specific surface area of greater than 7.5 m²/g.

The present disclosure provides a solid electrolyte material having a practical ion conductivity and having improved accessibility to another material.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 shows a cross-sectional view of a battery according to a second embodiment;

FIG. 2 shows a cross-sectional view of an electrode material according to the second embodiment; and

FIG. 3 shows a schematic diagram of a compression molding dies that is used for evaluating the ion conductivity of a solid electrolyte material.

### DETAILED DESCRIPTIONS

### Overview of One Aspect According to the Present Disclosure

A solid electrolyte material according to a first aspect of the present disclosure is a solid electrolyte material comprising Li, M, O, and X, wherein
M is at least one selected from the group consisting of Nb and Ta,
X is at least one selected from the group consisting of F, Cl, Br, and I, and
the solid electrolyte material has a specific surface area of greater than 7.5 m²/g.

The solid electrolyte material according to the first aspect has a practical ion conductivity and has a high specific surface area and good accessibility to another material, and therefore can improve the charge and discharge characteristics of a battery.

In a second aspect of the present disclosure, for example, in the solid electrolyte material according to the first aspect, X may include Cl.

The solid electrolyte material according to the second aspect has an improved ion conductivity.

In a third aspect of the present disclosure, for example, in the solid electrolyte material according to the first or second aspect, M may include Ta.

The solid electrolyte material according to the third aspect has an improved ion conductivity.

In a fourth aspect of the present disclosure, for example, in the solid electrolyte material according to any one of the first to third aspects, the molar ratio of Li to M may be 0.60 or more and 3.0 or less.

The solid electrolyte material according to the fourth aspect has a more improved ion conductivity.

In a fifth aspect of the present disclosure, for example, in the solid electrolyte material according to any one of the first to fourth aspects, the molar ratio of O to X may be 0.05 or more and 0.4 or less.

The solid electrolyte material according to the fifth aspect has more improved ion conductivity.

In a sixth aspect of the present disclosure, for example, in the solid electrolyte material according to any one of the first to fifth aspects, the specific surface area may be 9.8 m²/g or more.

The solid electrolyte material according to the sixth aspect has better accessibility to another material.

In a seventh aspect of the present disclosure, for example, in the solid electrolyte material according to any one of the first to sixth aspects, the specific surface area may be 20 m²/g or less.

The solid electrolyte material according to the seventh aspect can improve the charge and discharge characteristics of a battery.

In an eighth aspect of the present disclosure, for example, in the solid electrolyte material according to any one of the first to seventh aspects, the specific surface area may be 16.4 m²/g or less.

The solid electrolyte material according to the eighth aspect can improve the charge and discharge characteristics of a battery.

A manufacturing method according to a ninth aspect of the present disclosure is a manufacturing method of the solid electrolyte material according to any one of the first to eighth aspects, comprising
wet-pulverizing a mixture including a raw material composition including components of the solid electrolyte material and a solvent.

The manufacturing method according to the ninth aspect can manufacture a solid electrolyte material having a practical ion conductivity and a high specific surface area.

In a tenth aspect of the present disclosure, for example, in the manufacturing method according to the ninth aspect, the solvent may include at least one selected from the group consisting of heptane and para-chlorotoluene.

The manufacturing method according to the tenth aspect can manufacture a solid electrolyte material having a practical ion conductivity and a high specific surface area.

A battery according to an eleventh aspect of the present disclosure comprises:
a positive electrode;
a negative electrode; and
an electrolyte layer arranged between the positive electrode and the negative electrode, wherein
at least one selected from the group consisting of the positive electrode, the negative electrode, and the electrolyte layer contains the solid electrolyte material according to any one of the first to eighth aspects.

The battery according to the eleventh aspect has improved charge and discharge characteristics.

In a twelfth aspect the present disclosure, for example, in the battery according to the eleventh aspect, the positive electrode may contain the solid electrolyte material according to any one of the first to eighth aspects.

The battery according to the twelfth aspect has improved charge and discharge characteristics.

Embodiments of the present disclosure will now be described with reference to the drawings. The present disclosure is not limited to the following embodiments.

### First Embodiment

The solid electrolyte material according to a first embodiment is a solid electrolyte material including Li, M, O, and X. Here, M is at least one selected from the group consisting of Nb and Ta, X is at least one selected from the group consisting of F, Cl, Br, and I. The solid electrolyte material according to the first embodiment has a specific surface area of greater than 7.5 m²/g.

The specific surface area of the solid electrolyte material in the present disclosure means a specific surface area that is determined by a BET method.

The solid electrolyte material according to the first embodiment is suitable for lithium ion conduction and has good accessibility to another material. Accordingly, the solid electrolyte material according to the first embodiment can reduce the resistance of the interface with another material. Another material is, for example, an active material.

In general, a polycrystalline substance is used as an active material that is used in a lithium ion secondary battery. The surface of the active material is not flat and often has unevenness such as small grooves or depressions. Unlike an electrolyte solution system battery, in an all-solid-state battery, it is desired to improve the accessibility between an active material and a solid electrolyte in order to reduce the resistance of the battery. In order to do that, it is necessary to deform the solid electrolyte by, for example, compression, in accordance with the uneven shape of the active material. However, when the solid electrolyte has a flat surface and has a large particle diameter, the pressure during pressing is concentrated at protrusions on the active material surface, and good accessibility until the insides of recesses is not obtained. In contrast, when the particle diameter of the solid electrolyte is smaller than the recesses of the active material, pressure is applied to the solid electrolyte in a state of being stuck in the recesses, and thereby good accessibility is obtained. In addition, also when the solid electrolyte surface is uneven, the solid electrolyte easily enters the insides of recesses on the active material surface, compared to when the surface is flat, and thereby good accessibility between the solid electrolyte and the active material is easily realized. A small particle diameter or an uneven surface results in a large specific surface area. That is, a solid electrolyte having a large specific surface area easily realizes good accessibility with an active material. As a result, the resistance of a battery can be reduced, and, for example, the charge and discharge characteristics of a battery can be improved.

The solid electrolyte material according to the first embodiment has a practical ion conductivity and, for example, can have a high lithium ion conductivity. Here, an example of the high lithium ion conductivity is 0.1 mS/cm or more at around room temperature. The solid electrolyte material according to the first embodiment can have, for example, an ion conductivity of 0.1 mS/cm or more. That is, the solid electrolyte material according to the first embodiment is suitable for a lithium ion conduction.

The solid electrolyte material according to the first embodiment can be used for expressing excellent charge and discharge characteristics. An example of the battery is an all-solid-state battery. The all-solid-state battery may be a primary battery or may be a secondary battery.

From the viewpoint of safety, the solid electrolyte material according to the first embodiment is desirably essentially sulfur-free. The phrase “the solid electrolyte material according to the first embodiment is essentially sulfur-free” means that the solid electrolyte material does not include sulfur as a constituent element, except for sulfur that is unavoidably mixed in as an impurity. In this case, the amount of sulfur that is mixed in the solid electrolyte material as an impurity is, for example, 1 mol % or less. From the viewpoint of safety, the solid electrolyte material according to the first embodiment is desirably sulfur-free. The sulfur-free solid electrolyte material does not generate hydrogen sulfide even if exposed to the atmosphere and is therefore excellent in safety.

The solid electrolyte material according to the first embodiment may consist essentially of Li, M, O, and X. Here, the phrase “the solid electrolyte material according to the first embodiment consists essentially of Li, M, O, and X” means that the molar proportion of the sum of the amounts of Li, M, O, and X to the sum of the amounts of the all elements constituting the solid electrolyte material according to the first embodiment is 90% or more. As an example, the molar proportion may be 95% or more.

In order to enhance the ion conductivity of a solid electrolyte material, the solid electrolyte material according to the first embodiment may consist of Li, M, O, and X only.

In order to enhance the ion conductivity of a solid electrolyte material, in the solid electrolyte material according to the first embodiment, X may include Cl, or X may be Cl.

In order to enhance the ion conductivity of a solid electrolyte material, in the solid electrolyte material according to the first embodiment, M may include Ta, or M may be Ta.

In order to enhance the ion conductivity of a solid electrolyte material, in the solid electrolyte material according to the first embodiment, the molar ratio of Li to M (hereinafter, referred to as “Li/M molar ratio”) may be 0.60 or more and 3.0 or less. In the solid electrolyte material according to the first embodiment, the molar ratio of O to X (hereinafter, referred to as “O/X molar ratio”) may be 0.05 or more and 0.4 or less. The Li/M molar ratio may be 0.60 or more and 3.0 or less, and, at the same time, the O/X molar ratio may be 0.05 or more and 0.4 or less.

In order to enhance the ion conductivity of a solid electrolyte material, in the solid electrolyte material according to the first embodiment, the Li/M molar ratio may be 1.3 or more and 1.4 or less. The O/X molar ratio may be 0.2 or more and 0.26 or less. In the solid electrolyte material according to the first embodiment, the Li/M molar ratio may be 1.3 or more and 1.4 or less, and, at the same time, the O/X molar ratio may be 0.2 or more and 0.26 or less.

The specific surface area of the solid electrolyte material according to the first embodiment may be 9.8 m²/g or more.

The specific surface area of the solid electrolyte material according to the first embodiment may be 20 m²/g or less. The specific surface area may be 16.4 m²/g or less.

When the shape of the solid electrolyte material according to the first embodiment is particulate (e.g., spherical), the solid electrolyte material may have a median diameter of 0.1 μm or more and 100 μm or less or a median diameter of 0.5 μm or more and 10 μm or less. Consequently, the solid electrolyte material according to the first embodiment and other materials can be well dispersed. The median diameter of particles means a particle diameter (d50) corresponding to the 50% accumulated volume in a volume-based particle size distribution. The volume-based particle size distribution can be measured with a laser diffraction measurement apparatus or an image analyzer.

When the shape of the solid electrolyte material according to the first embodiment is particulate (e.g., spherical), the solid electrolyte material may have a median diameter smaller than that of an active material. Consequently, the solid electrolyte material according to the first embodiment and the active material can form a good dispersion state.

### Manufacturing Method of Solid Electrolyte Material

The solid electrolyte material according to the first embodiment can be manufactured by the following method.

Multiple raw material powders weighed so as to give a desired composition and an organic solvent are mixed while pulverizing them in a mixer.

First, raw material powders are provided so as to give a desired composition. Examples of the raw material power are an oxide, a hydroxide, a halide, and an acid halide.

As one example, in a solid electrolyte material constituted of Li, Ta, O, and Cl, when the values of the molar ratio Li/M and molar ratio O/X at the time of mixing the raw materials are set to 1.2 and 0.17, respectively, Li₂O, LiOH, and TaCl₅ are provided at a molar ratio of Li₂O:LiOH:TaCl₅=0.4:0.4:1.0.

The element types of M and X are determined by selecting the types of the raw material powders. The molar ratios Li/M and O/X are determined by selecting the mixing ratio of the raw material powders.

The raw material powders may be mixed at a molar ratio adjusted in advance such that the compositional change that may occur during the synthesis process is offset.

The raw material powders and organic solvent are put in a mixer such as a planetary ball mill and are mixed while pulverizing them. That is, treatment with a wet ball mill is performed. The raw material powders may be mixed before being put in a mixer.

After mixing, the balls are separated to obtain a slurry in which particles are dispersed. The slurry is dried at a temperature according to the boiling point of the used organic solvent to obtain a solid. This solid is pulverized in a mortar to obtain a reaction product.

The particle diameter of the product by pulverization can be decreased by performing the pulverization in a wet system. That is, the specific surface area of the solid electrolyte material can be improved.

A further decrease in the particle diameter of the solid obtained by drying the slurry can be expected by dissolving the solid in an organic solvent and performing recrystallization. Alternatively, the raw material powders of the solid electrolyte material are dissolved in an organic solvent and recrystallized to decrease the particle diameter, and then treatment with a wet ball mill may be performed.

The solid obtained by drying the slurry may be heat-treated in vacuum or in an inert atmosphere. The heat treatment is performed, for example, at 50° C. or more and 300° C. or less for 1 hour or more. In order to suppress the compositional change in the heat treatment, the heat treatment may be performed in an airtight container such as a quartz tube.

As described above, the solid electrolyte material according to the first embodiment is obtained by performing wet pulverization that pulverizes a mixture including a raw material composition including components of a solid electrolyte material and a solvent.

In order to enhance the specific surface area of a solid electrolyte material, the particle diameter of the balls that are used in a wet ball mill may be decreased. Alternatively, the amount of the balls that are used in a wet ball mill may be increased. Alternatively, the treatment time by a wet ball mill may be elongated.

The solvent that is used in a wet ball mill may include at least one selected from the group consisting of heptane and para-chlorotoluene.

After treatment with a wet ball mill, the solid electrolyte material obtained by drying out the solvent may be annealed.

The composition of a solid electrolyte material can be determined by, for example, inductively coupled plasma emission spectral analysis, ion chromatography, or an inert gas fusion-infrared absorption method. For example, the compositions of Li and M can be determined by inductively coupled plasma emission spectral analysis, the composition of X can be determined by ion chromatography, and O can be measured by an inert gas fusion-infrared absorption method.

### Second Embodiment

A second embodiment will now be described. The matters described in the first embodiment will be omitted as appropriate.

The battery according to the second embodiment includes a positive electrode, an electrolyte layer, and a negative electrode. The electrolyte layer is arranged between the positive electrode and the negative electrode. At least one selected from the group consisting of the positive electrode, the electrolyte layer, and the negative electrode contains the solid electrolyte material according to the first embodiment.

The battery according to the second embodiment contains the solid electrolyte material according to the first embodiment and thereby has excellent charge and discharge characteristics.

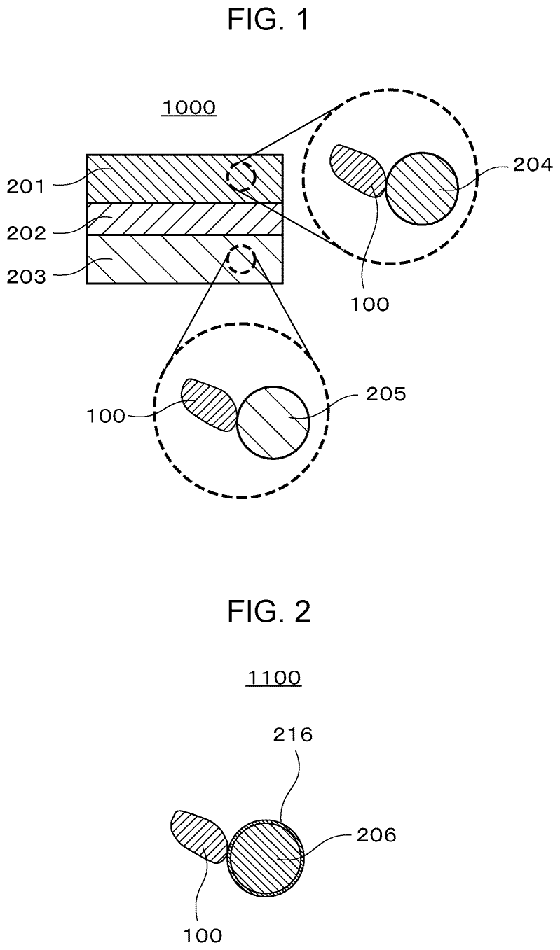

FIG. 1 shows a cross-sectional view of a battery 1000 according to the second embodiment.

The battery 1000 includes a positive electrode 201, an electrolyte layer 202, and a negative electrode 203. The electrolyte layer 202 is arranged between the positive electrode 201 and the negative electrode 203.

The positive electrode 201 contains a positive electrode active material particle 204 and a solid electrolyte particle 100.

The electrolyte layer 202 contains an electrolyte material. The electrolyte material is, for example, a solid electrolyte material.

The negative electrode 203 contains a negative electrode active material particle 205 and a solid electrolyte particle 100.

The solid electrolyte particle 100 is a particle including the solid electrolyte material according to the first embodiment. The solid electrolyte particle 100 may be a particle including the solid electrolyte material according to the first embodiment as a main component. The particle including the solid electrolyte material according to the first embodiment as a main component means a particle in which the component included at the highest molar ratio is the solid electrolyte material according to the first embodiment. The solid electrolyte particle 100 may be a particle consisting of the solid electrolyte material according to the first embodiment.

The positive electrode 201 contains a material that can occlude and release metal ions such as lithium ions. The positive electrode 201 contains, for example, a positive electrode active material (e.g., the positive electrode active material particle 204).

Examples of the positive electrode active material are a lithium-containing transition metal oxide, a transition metal fluoride, a polyanionic material, a fluorinated polyanionic material, a transition metal sulfide, a transition metal oxysulfide, and a transition metal oxynitride. Examples of the lithium-containing transition metal oxide are Li(Ni,Co,Al)O₂, Li(Ni,Co,Mn)O₂, and LiCoO₂.

In the present disclosure, “(A,B,C)” means “at least one selected from the group consisting of A, B, and C”.

From the viewpoint of the cost and safety of a battery, lithium phosphate may be used as the positive electrode active material.

The positive electrode 201 may contain the solid electrolyte material according to the first embodiment.

When the positive electrode 201 contains the solid electrolyte material according to the first embodiment and X includes I (i.e., iodine), iron lithium phosphate may be used as the positive electrode active material. The solid electrolyte material according to the first embodiment including I is easily oxidized. The oxidation reaction of the solid electrolyte material is suppressed by using iron lithium phosphate as the positive electrode active material. That is, formation of an oxide layer having a low lithium ion conductivity is suppressed. As a result, the battery has a high charge and discharge efficiency.

The positive electrode 201 may also contain a transition metal oxyfluoride as the positive electrode active material in addition to the solid electrolyte material according to the first embodiment. Even if the solid electrolyte material according to the first embodiment is fluorinated by a transition metal fluoride, a resistive layer is unlikely to be formed. As a result, the battery has a high charge and discharge efficiency.

The transition metal oxyfluoride contains oxygen and fluorine. As an example, the transition metal oxyfluoride may be a compound represented by a composition formula: LiₚMe_{q}OₘFₙ. Here, Me is at least one selected from the group consisting of Mn, Co, Ni, Fe, Al, Cu, V, Nb, Mo, Ti, Cr, Zr, Zn, Na, K, Ca, Mg, Pt, Au, Ag, Ru, W, B, Si, and P, and mathematical expressions: 0.5≤p≤1.5, 0.5≤q≤1.0, 1≤m<2, and 0<n≤1 are satisfied. An example of such transition metal oxyfluoride is Li_{1.05}(Ni_{0.35}Co_{0.35}Mn_{0.3})_{0.95}O_{1.9}F_{0.1}.

The positive electrode active material particle 204 may have a median diameter of 0.1 μm or more and 100 μm or less. When the positive electrode active material particle 204 has a median diameter of 0.1 μm or more, the positive electrode active material particle 204 and the solid electrolyte particle 100 can be well dispersed in the positive electrode 201. Consequently, the charge and discharge characteristics of a battery are improved. When the positive electrode active material particle 204 has a median diameter of 100 μm or less, the lithium diffusion speed in the positive electrode active material particle 204 is improved. Consequently, the battery can operate at a high output.

The positive electrode active material particle 204 may have a median diameter larger than that of the solid electrolyte particle 100. Consequently, the positive electrode active material particle 204 and the solid electrolyte particle 100 can be well dispersed in the positive electrode 201.

In order to improve the energy density and output of the battery, the ratio of the volume of the positive electrode active material particle 204 to the sum of the volume of the positive electrode active material particle 204 and the volume of the solid electrolyte particle 100 in the positive electrode 201 may be 0.30 or more and 0.95 or less.

FIG. 2 shows a cross-sectional view of an electrode material 1100 according to the second embodiment. The electrode material 1100 is included in, for example, the positive electrode 201. In order to prevent the solid electrolyte particle 100 from reacting with the positive electrode active material (i.e., the electrode active material particle 206), a covering layer 216 may be formed on the surface of the electrode active material particle 206. Consequently, an increase in the reaction overvoltage of the battery can be suppressed. Examples of the covering material included in the covering layer 216 are a sulfide solid electrolyte, an oxide solid electrolyte, and a halide solid electrolyte.

When the solid electrolyte particle 100 is a sulfide solid electrolyte, the covering material may be the solid electrolyte material according to the first embodiment, and X may be at least one selected from the group consisting of Cl and Br. Such solid electrolyte material according to the first embodiment is less likely to be oxidized compared to the sulfide solid electrolyte. As a result, an increase in the reaction overvoltage of the battery can be suppressed.

When the solid electrolyte particle 100 is the solid electrolyte material according to the first embodiment and X includes I, the covering material may be the solid electrolyte material according to the first embodiment, and X may be at least one selected from the group consisting of Cl and Br. The solid electrolyte material according to the first embodiment not including I is less likely to be oxidized compared to the solid electrolyte material according to the first embodiment including I. As a result, the battery has a high charge and discharge efficiency.

When the solid electrolyte particle 100 is the solid electrolyte material according to the first embodiment and X includes I, the covering material may include an oxide solid electrolyte. The oxide solid electrolyte may be lithium niobate, which has excellent stability even at a high potential. Consequently, the battery has a high charge and discharge efficiency.

The positive electrode 201 may be composed of a first positive electrode layer containing a first positive electrode active material and a second positive electrode layer containing a second positive electrode active material. Here, the second positive electrode layer is arranged between the first positive electrode layer and the electrolyte layer 202, the first positive electrode layer and the second positive electrode layer contain the solid electrolyte material according to the first embodiment including I, and the covering layer 216 is formed on the surface of the second positive electrode active material. According to the above configuration, the solid electrolyte material according to the first embodiment included in the electrolyte layer 202 can be suppressed from being oxidized by the second positive electrode active material. As a result, the battery has a high charging capacity.

Examples of the covering material included in the covering layer 216 are a sulfide solid electrolyte, an oxide solid electrolyte, a polymeric solid electrolyte, and a halide solid electrolyte. However, when the covering material is a halide solid electrolyte, I is not included as the halogen element. The first positive electrode active material may be a material that is the same as the second positive electrode active material or a material that is different from the second positive electrode active material.

In order to improve the energy density and output of the battery, the positive electrode 201 may have a thickness of 10 μm or more and 500 μm or less.

The electrolyte layer 202 contains an electrolyte material. The electrolyte material is, for example, a solid electrolyte material. The electrolyte layer 202 may be a solid electrolyte layer. The electrolyte layer 202 may contain the solid electrolyte material according to the first embodiment. The electrolyte layer 202 may consist of only the solid electrolyte material according to the first embodiment.

The electrolyte layer 202 may consist of only a solid electrolyte material that is different from the solid electrolyte material according to the first embodiment. Examples of the solid electrolyte material that is different from the solid electrolyte material according to the first embodiment are Li₂MgX′₄, Li₂FeX′₄, Li(Al,Ga,In)X′₄, Li₃(Al,Ga,In)X′₆, and LiI. Here, X′ is at least one selected from the group consisting of F, Cl, Br, and I.

Hereinafter, the solid electrolyte material according to the first embodiment is referred to as first solid electrolyte material, and the solid electrolyte material that is different from the solid electrolyte material according to the first embodiment is referred to as second solid electrolyte material.

The electrolyte layer 202 may contain a second solid electrolyte material, in addition to a first solid electrolyte material. The first solid electrolyte material and the second solid electrolyte material may be uniformly dispersed. A layer consisting of the first solid electrolyte material and a layer consisting of the second solid electrolyte material may be stacked along the stacking direction of the battery 1000.

The electrolyte layer 202 may have a thickness of 1 μm or more and 100 μm or less. When the electrolyte layer 202 has a thickness of 1 μm or more, the positive electrode 201 and the negative electrode 203 are less likely to short circuit. When the electrolyte layer 202 has a thickness of 100 μm or less, the battery can operate at a high output.

Another electrolyte layer may be further provided between the electrolyte layer 202 and the negative electrode 203. For example, when the electrolyte layer 202 includes the first solid electrolyte material, in order to more stably maintain the high ion conductivity of the first solid electrolyte material, an electrolyte layer constituted of another solid electrolyte material that is electrochemically stable than the first solid electrolyte material may be further provided between the electrolyte layer 202 and the negative electrode 203.

The negative electrode 203 contains a material that can occlude and release metal ions (e.g., lithium ions). The negative electrode 203 contains, for example, a negative electrode active material (e.g., the negative electrode active material particle 205).

Examples of the negative electrode active material are a metal material, a carbon material, an oxide, a nitride, a tin compound, and a silicon compound. The metal material may be a single metal or may be an alloy. Examples of the metal material are a lithium metal and a lithium alloy. Examples of the carbon material are natural graphite, coke, graphitizing carbon, carbon fibers, spherical carbon, artificial graphite, and amorphous carbon. From the viewpoint of capacity density, suitable examples of the negative electrode active material are silicon (i.e., Si), tin (i.e., Sn), a silicon compound, and a tin compound.

The negative electrode active material may be selected based on the reduction resistance of the solid electrolyte material included in the negative electrode 203. When the negative electrode 203 contains the first solid electrolyte material, a material that can occlude and release lithium ions at 0.27 V or more with respect to lithium may be used as the negative electrode active material. When the negative electrode active material is such a material, it is possible to suppress the first solid electrolyte material included in the negative electrode 203 from being reduced. As a result, the battery has a high charge and discharge efficiency. Examples of the material are a titanium oxide, an indium metal, and a lithium alloy. Examples of the titanium oxide are Li₄Ti₅O₁₂, LiTi₂O₄, and TiO₂.

The negative electrode active material particle 205 may have a median diameter of 0.1 μm or more and 100 μm or less. When the negative electrode active material particle 205 has a median diameter of 0.1 μm or more, the negative electrode active material particle 205 and the solid electrolyte particle 100 can be well dispersed in the negative electrode 203. Consequently, the charge and discharge characteristics of the battery are improved. When the negative electrode active material particle 205 has a median diameter of 100 μm or less, the lithium diffusion speed in the negative electrode active material particle 205 is improved. Consequently, the battery can operate at a high output.

The negative electrode active material particle 205 may have a median diameter larger than that of the solid electrolyte particle 100. Consequently, the negative electrode active material particle 205 and the solid electrolyte particle 100 can be well dispersed in the negative electrode 203.

In order to improve the energy density and output of the battery, the ratio of the volume of the negative electrode active material particle 205 to the sum of the volume of the negative electrode active material particle 205 and the volume of the solid electrolyte particle 100 in the negative electrode 203 may be 0.30 or more and 0.95 or less.

The electrode material 1100 shown in FIG. 2 may be contained in the negative electrode 203. In order to prevent the solid electrolyte particle 100 from reacting with the negative electrode active material (i.e., the electrode active material particle 206), a covering layer 216 may be formed on the surface of the electrode active material particle 206. Consequently, the battery has a high charge and discharge efficiency. Examples of the covering material included in the covering layer 216 are a sulfide solid electrolyte, an oxide solid electrolyte, a polymeric solid electrolyte, and a halide solid electrolyte.

When the solid electrolyte particle 100 is a first solid electrolyte material, the covering material may be a sulfide solid electrolyte, an oxide solid electrolyte, or a polymeric solid electrolyte. An example of the sulfide solid electrolyte is Li₂S—P₂S₅. An example of the oxide solid electrolyte is trilithium phosphate. Examples of the polymeric solid electrolyte are polyethylene oxide and a conjugated compound of a lithium salt. An example of the polymeric solid electrolyte is lithium bis(trifluoromethanesulfonyl)imide.

In order to improve the energy density and output of the battery, the negative electrode 203 may have a thickness of 10 μm or more and 500 μm or less.

At least one selected from the group consisting of the positive electrode 201, the electrolyte layer 202, and the negative electrode 203 may contain a second solid electrolyte material for the purpose of enhancing the ion conductivity. Examples of the second solid electrolyte material are a sulfide solid electrolyte, an oxide solid electrolyte, a halide solid electrolyte, and an organic polymeric solid electrolyte.

In the present disclosure, the term “sulfide solid electrolyte” means a solid electrolyte containing sulfur. The term “oxide solid electrolyte” means a solid electrolyte containing oxygen. The oxide solid electrolyte may contain an anion (excluding a sulfur anion and a halogen anion) in addition to oxygen. The term “halide solid electrolyte” means a solid electrolyte containing a halogen element and not containing sulfur. The halide solid electrolyte may contain oxygen in addition to a halogen element.

Examples of the sulfide solid electrolyte are Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂S₁₂.

Examples of the oxide solid electrolyte are:
(i) an NASICON-type solid electrolyte, such as LiTi₂(PO₄)₃ or an element substitute thereof;
(ii) a perovskite-type solid electrolyte, such as (LaLi)TiO₃;
(iii) an LISICON-type solid electrolyte, such as Li₁₄ZnGe₄O₁₆, Li₄SiO₄, LiGeO₄, or an element substitute thereof;
(iv) a garnet-type solid electrolyte, such as Li₇La₃Zr₂O₁₂ or an element substitute thereof; and (v) Li₃PO₄ or an N-substitute thereof.

Examples of the halide solid electrolyte are compounds represented by LiₐMe′_{b}Y_{c}Z₆. Here, mathematical expressions: a+mb+3c=6 and c>0 are satisfied. Me′ is at least one selected from the group consisting of metal elements other than Li and Y and metalloid elements. Z is at least one selected from the group consisting of F, Cl, Br, and I. The value of m represents the valence of Me′.

The “metalloid elements” are B, Si, Ge, As, Sb, and Te. The “metal elements” are all elements included in Groups 1 to 12 of the periodic table (however, hydrogen is excluded) and all elements included in Groups 13 to 16 in the periodic table (however, B, Si, Ge, As, Sb, Te, C, N, P, O, S, and Se are excluded).

In order to enhance the ion conductivity of the halide solid electrolyte, Me′ may be at least one selected from the group consisting of Mg, Ca, Sr, Ba, Zn, Sc, Al, Ga, Bi, Zr, Hf, Ti, Sn, Ta, and Nb.

Examples of the halide solid electrolyte are Li₃YCl₆ and Li₃YBr₆.

When the electrolyte layer 202 contains the first solid electrolyte material, the negative electrode 203 may contain a sulfide solid electrolyte. Consequently, the sulfide solid electrolyte, which is electrochemically stable against the negative electrode active material, suppresses the first solid electrolyte material and the negative electrode active material from becoming in contact with each other. As a result, the battery has low internal resistance.

Examples of the organic polymeric solid electrolyte are a polymeric compound and a compound of a lithium salt. The polymeric compound may have an ethylene oxide structure. A polymeric compound having an ethylene oxide structure can contain a large amount of a lithium salt and therefore has a higher ion conductivity.

Examples of the lithium salt are LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from these salts may be used alone, or a mixture of two or more lithium salts selected from these salts may be used.

At least one selected from the group consisting of the positive electrode 201, the electrolyte layer 202, and the negative electrode 203 may contain a nonaqueous electrolyte solution, a gel electrolyte, or an ionic liquid for the purpose of facilitating the transfer of lithium ions and improving the output characteristics of the battery.

The nonaqueous electrolyte solution includes a nonaqueous solvent and a lithium salt dissolved in the nonaqueous solvent. Examples of the nonaqueous solvent are a cyclic carbonate solvent, a chain carbonate solvent, a cyclic ether solvent, a chain ether solvent, a cyclic ester solvent, a chain ester solvent, and a fluorine solvent. Examples of the cyclic carbonate solvent are ethylene carbonate, propylene carbonate, and butylene carbonate. Examples of the chain carbonate solvent are dimethyl carbonate, ethyl methyl carbonate, and diethyl carbonate. Examples of the cyclic ether solvent are tetrahydrofuran, 1,4-dioxane, and 1,3-dioxolane. Examples of the chain ether solvent are 1,2-dimethoxyethane and 1,2-diethoxyethane. An example of the cyclic ester solvent is γ-butyrolactone. An example of the chain ester solvent is methyl acetate. Examples of the fluorine solvent are fluoroethylene carbonate, methyl fluoropropionate, fluorobenzene, fluoroethyl methyl carbonate, and fluorodimethylene carbonate. One nonaqueous solvent selected from these solvents may be used alone. Alternatively, a mixture of two or more nonaqueous solvents selected from these solvents may be used.

Examples of the lithium salt are LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. One lithium salt selected from these salts may be used alone. Alternatively, a mixture of two or more lithium salts selected from these salts may be used. The concentration of the lithium salt is, for example, in a range of 0.5 mol/L or more and 2 mol/L or less.

As the gel electrolyte, a polymer material impregnated with a nonaqueous electrolyte solution can be used. Examples of the polymer material are polyethylene oxide, polyacrylonitrile, polyvinylidene fluoride, polymethyl methacrylate, and a polymer having an ethylene oxide bond.

Examples of the cation included in the ionic liquid are:
(i) an aliphatic chain quaternary salt, such as tetraalkylammonium or tetraalkylphosphonium;
(ii) an aliphatic cyclic ammonium, such as a pyrrolidinium, a morpholinium, an imidazolinium, a tetrahydropyrimidinium, a piperazinium, or a piperidinium; and
(iii) a nitrogen-containing heterocyclic aromatic cation, such as a pyridinium or an imidazolium.

Examples of the anion included in the ionic liquid are PF₆⁻, BF₄⁻, SbF₆⁻, AsF₆⁻, SO₃CF₃⁻, N(SO₂CF₃)₂⁻, N(SO₂C₂F₅)₂⁻, N(SO₂CF₃)(SO₂C₄F₉)⁻, and C(SO₂CF₃)₃⁻.

The ionic liquid may contain a lithium salt.

At least one selected from the group consisting of the positive electrode 201, the electrolyte layer 202, and the negative electrode 203 may contain a binder for the purpose of improving the adhesion between individual particles.

Examples of the binder are polyvinylidene fluoride, polytetrafluoroethylene, polyethylene, polypropylene, an aramid resin, polyamide, polyimide, polyamideimide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyether sulfone, hexafluoropolypropylene, styrene butadiene rubber, and carboxymethyl cellulose. A copolymer may also be used as the binder. Examples of the binder are copolymers of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. A mixture of two or more selected from the above materials may be used.

At least one selected from the group consisting of the positive electrode 201 and the negative electrode 203 may contain a conductive assistant for the purpose of enhancing the electron conductivity.

Examples of the conductive assistant are:
(i) graphite, such as natural graphite or artificial graphite;
(ii) carbon black, such as acetylene black or Ketjen black;
(iii) conductive fibers, such as carbon fibers or metal fibers;
(iv) carbon fluoride;
(v) metal powders, such as aluminum;
(vi) a conductive whisker, such as zinc oxide or potassium titanate;
(vii) a conductive metal oxide, such as titanium oxide; and
(viii) a conductive polymeric compound, such as polyaniline, polypyrrole, or polythiophene.
   In order to reduce the cost, the conductive assistant of the above (i) or (ii) may be used.

Examples of the shape of the battery according to the second embodiment are coin type, cylindrical type, square type, sheet type, button type, flat type, and stacked type.

The battery according to the second embodiment may be manufactured by, for example, providing a material for forming a positive electrode, a material for forming an electrolyte layer, and a material for forming a negative electrode and producing a stack in which a positive electrode, an electrolyte layer, and a negative electrode are arranged in this order by a known method.

### EXAMPLES

The present disclosure will now be described in more detail with reference to Examples.

### Example 1

### Production of Solid Electrolyte Material

Li₂O, LiOH, and TaCl₅ were provided at a molar ratio of Li₂O:LiOH:TaCl₅=0.4:0.4:1.0 in an argon atmosphere having a dew point of −60° C. or less (hereinafter, referred to as “dry argon atmosphere”). A mixture (1 g) of these raw material powders was put in a 45-mL pot of a planetary ball mill together with balls (25 g) with a diameter of 0.5 mm. Heptane (16 g) was dropwise added to the pot as an organic solvent.

Milling treatment was performed using a planetary ball mill at 600 rpm for 12 hours. After the milling treatment, the balls were separated to obtain a slurry.

The obtained slurry was dried using a mantle heater under a nitrogen flow at 50° C. for 1 hour. The resulting solid was pulverized with a mortar to obtain a powder of a solid electrolyte material of Example 1.

### Composition Analysis of Solid Electrolyte Material

The Li and M contents of the solid electrolyte material were measured by high-frequency inductively coupled plasma emission spectral analysis using a high-frequency inductively coupled plasma emission spectral analyzer (manufactured by ThermoFisher Scientific, iCAP 7400). The Cl content was measured by ion chromatography using an ion chromatographic apparatus (manufactured by Dionex, ICS-2000). The O content was measured by an inert gas fusion-infrared absorption method using an oxygen analyzer (manufactured by HORIBA, Ltd., EMGA-930). Li/M and O/X molar ratios were calculated from the measurement results. The Li/M molar ratio and the O/X molar ratio of the solid electrolyte material of Example 1 were 1.3 and 0.20, respectively.

### Evaluation of Ion Conductivity

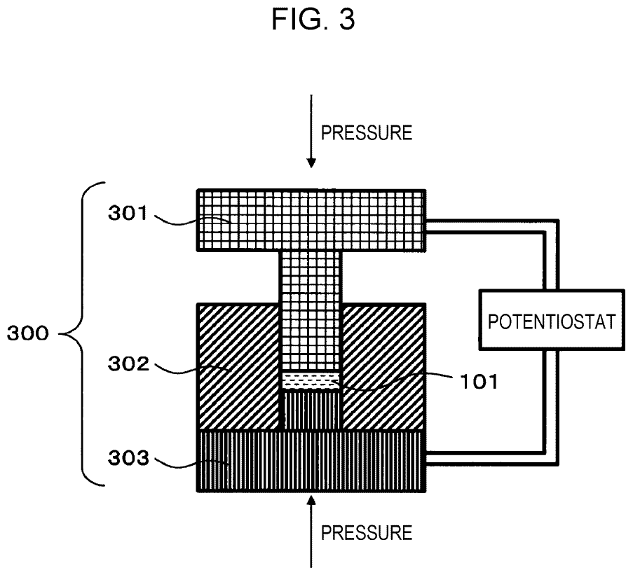

FIG. 3 shows a schematic diagram of a compression molding dies 300 that is used for evaluating the ion conductivity of a solid electrolyte material.

The compression molding dies 300 included a punch upper part 301, a die 302, and a punch lower part 303. The die 302 was formed from insulating polycarbonate. The punch upper part 301 and the punch lower part 303 were both formed from electron-conductive stainless steel.

The ion conductivity of the solid electrolyte material of Example 1 was measured using the compression molding dies 300 shown in FIG. 3 by the following method.

A powder of the solid electrolyte material of Example 1 (i.e., the powder 101 of the solid electrolyte material in FIG. 3) was loaded inside the compression molding dies 300 in a dry atmosphere. A pressure of 300 MPa was applied to the solid electrolyte material of Example 1 inside the compression molding dies 300 using the punch upper part 301.

While applying the pressure to the evaluation cell, the punch upper part 301 and the punch lower part 303 were connected to a potentiostat (Princeton Applied Research, VersaSTAT4) equipped with a frequency response analyzer. The punch upper part 301 was connected to the working electrode and the potential measurement terminal. The punch lower part 303 was connected to the counter electrode and the reference electrode. The ion conductivity of the solid electrolyte material of Example 1 was measured by an electrochemical impedance measurement method at room temperature. As a result, the ion conductivity measured at 22° C. was 0.12 mS/cm.

### Measurement of Specific Surface Area

The specific surface area was measured using a specific surface area/pore distribution analyzer (manufactured by MicrotracBEL Corp., BELSORP MINI X). Hereinafter, the specific surface area obtained using this apparatus is referred to as a BET specific surface area.

A powder (about 1 g) of the solid electrolyte material of Example 1 was put in a dedicated test tube in a dry atmosphere having a dew point of −40° C. or less.

As pretreatment, vacuum drying was performed at 80° C. for 1 hour.

The mass that was put in was measured from the difference between the weight of the test tube containing the sample after the pretreatment and the weight of the test tube before the putting of the sample.

The BET specific surface area was measured using the pretreated test tube, and the result was that the solid electrolyte material of Example 1 had a specific surface area of 16.4 m²/g.

### Examples 2 to 4

### Production of Solid Electrolyte Material

In Example 2, a solid electrolyte material of Example 2 was obtained as in Example 1 except that the solid obtained after drying out the solvent was post-annealed at 150° C. for 60 minutes.

In Example 3, a solid electrolyte material of Example 3 was obtained as in Example 1 except that para-chlorotoluene was used as the organic solvent and that the solvent was dried out at 170° C.

In Example 4, a solid electrolyte material of Example 4 was obtained as in Example 3 except that the solid obtained after drying out the solvent was post-annealed at 200° C. for 60 minutes.

The conditions for producing the solid electrolyte materials of Examples 2 to 4 are shown in Table 1.

### Composition Analysis of Solid Electrolyte Material

Composition analysis of the solid electrolyte materials of Examples 2 to 4 was carried out as in Example 1. The molar ratios Li/M and O/X of the solid electrolyte materials of Examples 2 to 4 are shown in Table 1.

### Evaluation of Ion Conductivity

The ion conductivity of each of the solid electrolyte materials of Examples 2 to 4 was measured as in Example 1. The measurement results are shown in Table 1.

### Measurement of Specific Surface Area

The BET specific surface area of each of the solid electrolyte materials of Examples 2 to 4 was measured as in Example 1. The measurement results are shown in Table 1.

### Reference Example 1

### Production of Solid Electrolyte Material

Li₂O, LiOH, and TaCl₅ were provided at a molar ratio of Li₂O:LiOH:TaCl₅=0.4:0.4:1.0 in the dry argon atmosphere. A mixture (1 g) of these raw material powders was put in a 45-mL pot of a planetary ball mill together with balls (25 g) with a diameter of 5 mm.

Milling treatment was performed using a planetary ball mill at 600 rpm for 12 hours. Thus, a powder of a solid electrolyte material of Reference Example 1 was obtained.

As described above, the solid electrolyte material of Reference Example 1 was produced with a dry ball mill not using an organic solvent.

### Composition Analysis of Solid Electrolyte Material

Composition analysis of the solid electrolyte material of Reference Example 1 was carried out as in Example 1. The molar ratios Li/M and O/X of the solid electrolyte material of Reference Example 1 are shown in Table 1.

### Evaluation of Ion Conductivity

The ion conductivity of the solid electrolyte material of Reference Example 1 was measured as in Example 1. The measurement result is shown in Table 1.

### Measurement of Specific Surface Area

The BET specific surface area of the solid electrolyte material of Reference Example 1 was measured as in Example 1. The measurement result is shown in Table 1.

### Reference Example 2

Li₂O, LiOH, and TaCl₅ were provided at a molar ratio of Li₂O:LiOH:TaCl₅=0.4:0.4:1.0 in the dry argon atmosphere. These materials were pulverized and mixed in an agate mortar. The obtained mixture was placed in a quartz glass container filled with argon gas and were heat-treated at 350° C. for 3 hours. The resulting heat-treated product was pulverized in an agate mortar.

As described above, the solid electrolyte material of Reference Example 2 was obtained by heat-treating a mixture of the raw materials.

### Composition Analysis of Solid Electrolyte Material

Composition analysis of the solid electrolyte material of Reference Example 2 was carried out as in Example 1. Molar ratios Li/M and O/X of the solid electrolyte material of Reference Example 2 are shown in Table 1.

### Evaluation of Ion Conductivity

The ion conductivity of the solid electrolyte material of Reference Example 2 was measured as in Example 1. The measurement result is shown in Table 1.

### Measurement of Specific Surface Area

The BET specific surface area of the solid electrolyte material of Reference Example 2 was measured as in Example 1. The measurement result is shown in Table 1.

TABLE 1

| | | | | | | | | | | | | BET |
|---|---|---|---|---|---|---|---|---|---|---|---|---|
| | | | | | | | | | Solvent | Post- | | specific |
| | | Li/M | O/X | | | Ball | | | drying out | annealing | Ion | surface |
| | Constituent | molar | molar | Synthesis | | diameter | Treatment | | temperature | temperature | conductivity | area |
| | element | ratio | ratio | method | Solvent | (mm) | condition | | (° C.) | (° C.) | (mS/cm) | (m²/g) |
| Example 1 | Li, Ta, O, Cl | 1.3 | 0.2 | Wet BM | Heptane | 0.5 | 600 | rpm | 50 | — | 0.12 | 16.4 |
| | | | | | | | 12 | hr | | | | |
| Example 2 | Li, Ta, O, Cl | 1.3 | 0.2 | Wet BM | Heptane | 0.5 | 600 | rpm | 50 | 150 | 1.3 | 11 |
| | | | | | | | 12 | hr | | | | |
| Example 3 | Li, Ta, O, Cl | 1.4 | 0.26 | Wet BM | Para- | 0.5 | 600 | rpm | 170 | — | 1.7 | 11.2 |
| | | | | | chlorotoluene | | 12 | hr | | | | |
| Example 4 | Li, Ta, O, Cl | 1.4 | 0.26 | Wet BM | Para- | 0.5 | 600 | rpm | 170 | 200 | 3.9 | 9.8 |
| | | | | | chlorotoluene | | 12 | hr | | | | |
| Reference | Li, Ta, O, Cl | 1.2 | 0.17 | Dry BM | — | 5 | 600 | rpm | — | — | 6 | 7.5 |
| Example | | | | | | | 12 | hr | | | | |
| 1 | | | | | | | | | | | | |
| Reference | Li, Ta, O, Cl | 2.0 | 0.39 | Heat | — | — | 350° | C. | — | — | 4.2 | 1.5 |
| Example | | | | treatment | | | 3 | hr | | | | |
| 2 | | | | | | | | | | | | |

### Consideration

The solid electrolyte materials of Examples 1 to 4 each have an ion conductivity of 0.1 mS/cm or more at room temperature and a specific surface area of greater than 7.5 m²/g. In contrast, the solid electrolyte material of Reference Example 1 produced with a dry ball mill and the solid electrolyte material of Reference Example 2 produced by heat treatment both had a specific surface areas of 7.5 m²/g or less.

Ta and Nb are both transition metal elements in Group 5. Accordingly, even if part or the whole of Ta is substituted with Nb, the solid electrolyte material of the present disclosure can have a practical ion conductivity and a high specific surface area. Similarly, even if part or the whole of Cl, which is a halogen element, is substituted with at least one selected from the group consisting of F, Br, and I, the solid electrolyte material of the present disclosure can have a practical ion conductivity and a high specific surface area.

As described above, the solid electrolyte material of the present disclosure has a practical ion conductivity and a high specific surface area and therefore can realize good contact with an active material. Accordingly, the solid electrolyte material of the present disclosure is suitable for providing a battery having excellent charge and discharge characteristics.

The solid electrolyte material of the present disclosure is utilized in, for example, an all-solid-state lithium ion secondary battery.

What is claimed is:

1. A solid electrolyte material comprising Li, M, O, and X, wherein
M is at least one selected from the group consisting of Nb and Ta,
X is at least one selected from the group consisting of F, Cl, Br, and I, and
the solid electrolyte material has a specific surface area of greater than 7.5 m²/g.

2. The solid electrolyte material according to claim 1, wherein
X includes Cl.

3. The solid electrolyte material according to claim 1, wherein
M includes Ta.

4. The solid electrolyte material according to claim 1, wherein
a molar ratio of Li to M is 0.60 or more and 3.0 or less.

5. The solid electrolyte material according to claim 1, wherein
a molar ratio of O to X is 0.05 or more and 0.4 or less.

6. The solid electrolyte material according to claim 1, wherein
the specific surface area is 9.8 m²/g or more.

7. The solid electrolyte material according to claim 1, wherein
the specific surface area is 20 m²/g or less.

8. The solid electrolyte material according to claim 7, wherein
the specific surface area is 16.4 m²/g or less.

9. A method for manufacturing the solid electrolyte material according to claim 1, the method comprising:
wet-pulverizing a mixture including a raw material composition including components of the solid electrolyte material and a solvent.

10. The manufacturing method according to claim 9, wherein
the solvent includes at least one selected from the group consisting of heptane and para-chlorotoluene.

11. A battery comprising:
a positive electrode;
a negative electrode; and
an electrolyte layer arranged between the positive electrode and the negative electrode, wherein
at least one selected from the group consisting of the positive electrode, the negative electrode, and the electrolyte layer contains the solid electrolyte material according to claim 1.

12. The battery according to claim 11, wherein
the positive electrode contains a solid electrolyte material comprising Li, M, O, and X, wherein M is at least one selected from the group consisting of Nb and Ta, X is at least one selected from the group consisting of F, Cl, Br, and I, and the solid electrolyte material has a specific surface area of greater than 7.5 m²/g.
